(19) United States
(12) Patent Application Publication
(10) Pub. No.: US 2025/0303217 A1
(43) Pub. Date: Oct. 2, 2025

(54) SPORTS TRAINING AND REHABILITATION DEVICE

(71) Applicant: A1 & D1 Enterprise Inc., Boca Raton, FL (US)

(72) Inventor: Daniel MacNair PULLUM, Boca Raton, FL (US)

(21) Appl. No.: 18/957,965

(22) Filed: Nov. 25, 2024

Related U.S. Application Data
(60) Provisional application No. 63/571,803, filed on Mar. 29, 2024.

(51) Int. Cl. A63B 21/008; A63B 21/06; A63B 60/50; A63B 69/38

(52) U.S. Cl. CPC A63B 21/0084; A63B 21/06; A63B 60/50; A63B 69/38; A63B 2208/03; A63B 2214/00; A63B 2225/60

(57) ABSTRACT

A device configured for use as a sports training and/or rehabilitation device. In one embodiment, the device includes a head portion, a handle portion meeting the head portion, and a resistance element within the head portion. In one embodiment, the resistance element defines a plurality of apertures through which a fluid may flow when the device is in use. In one embodiment, the device has a weight of between approximately 6 ounces and approximately 36 ounces.

### CROSS-REFERENCE TO RELATED APPLICATIONS

This Application claims the benefit of U.S. Provisional Patent Application No. 63/571,803, filed Mar. 29, 2024, entitled SPORTS TRAINING DEVICE, the entirety of which is incorporated herein by reference.

### GOVERNMENT RIGHTS STATEMENT

N/A.

### TECHNICAL FIELD

This disclosure relates to a sports training and rehabilitation device. In particular, this disclosure relates to a sports training and rehabilitation device that may be used underwater for strengthening and training muscles to avoid or recover from injury.

### BACKGROUND

Various sports training and/or rehabilitation devices for increasing muscle strength, agility, stamina, and/or recovery, such as hand weights, resistance bands, weighted sleds, agility trainers, weight machines, speed bikes, jump ropes, balls, sandbags, rowing machines, and a vast number of others. Which device to use may generally depend on the intended purpose (for example, sports training, rehabilitation after injury or surgery, muscle recovery following a workout, fitness and/or weight loss, etc.), as well as the user's level of fitness, severity of injury, body confirmation, and area of the body to be treated or trained.

Water fitness and rehabilitation devices are known, such as weight belts, paddleboards, kickboards, aqua fitness barbells, and others. However, devices suitable for on-land use are typically not configured for use in water, and such devices may be ideal for training in a particular sport or to rehabilitate a particular muscle or muscle group. For example, hand weights, tennis or badminton rackets, and baseball bats are not for use in a recovery or training regimen that requires pool exercises.

### SUMMARY

Some embodiments advantageously provide a sports training and/or rehabilitation device. In one embodiment, the device includes: a head portion at a first end of the device; a handle portion at a second end of the device; and a resistance element within and extending across the head portion.

In one aspect of the embodiment, the head portion is at least substantially planar.

In one aspect of the embodiment, the resistance element is at least substantially planar and is coplanar with the head portion.

In one aspect of the embodiment, the resistance element defines a plurality of apertures.

In one aspect of the embodiment, the plurality of apertures are configured to allow a flow of fluid to pass therethrough when the device is in use.

In one aspect of the embodiment, the device weighs between approximately 6 ounces and approximately 36 ounces.

In one aspect of the embodiment, the device weighs at least 30 ounces.

In one aspect of the embodiment, the resistance element is at least partially defined by a plurality of elongate elements.

In one aspect of the embodiment, the resistance element includes a central portion, the plurality of elongate elements including a linear first elongate element and a linear second elongate element, the linear first elongate element and the linear second elongate element intersecting at the central portion.

In one aspect of the embodiment, the plurality of elongate elements further includes a plurality of curved elongate elements.

In one aspect of the embodiment, each of the linear first elongate element and the linear second elongate element terminates at a corresponding one of the plurality of curved elongate elements.

In one aspect of the embodiment, the device further includes a throat region, the throat region being positioned between the head portion and the handle portion.

In one aspect of the embodiment, the throat region defines a throat aperture.

In one aspect of the embodiment, the head portion and the resistance element are formed as a single, unitary piece.

In one aspect of the embodiment, the head portion defines a head aperture, the resistance element being attached within the head aperture.

In one aspect of the embodiment, the resistance element does not include a plurality of interwoven strings.

In one embodiment, a device includes: a head portion at a first end of the device, the head portion defining a head aperture; a handle portion at a second end of the device; and a resistance element within and extending across the head aperture, the device having a weight of between approximately 6 ounces and approximately 36 ounces.

In one aspect of the embodiment, the head portion is at least substantially planar and the resistance element is at least substantially planar, the resistance element being coplanar with the head portion.

In one aspect of the embodiment, the resistance element defines a plurality of apertures.

In one embodiment, a method of physical rehabilitation and sports training includes: moving a sports training device at least partially beneath a surface of water, the sports training device including: a head portion at a first end of the device, the head portion defining a head aperture; a handle portion at a second end of the device; and a resistance element within and extending across the head aperture, the device having a weight of between approximately 6 ounces and approximately 36 ounces.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a front perspective view of an exemplary sports training device, in accordance with the present disclosure;

FIG. 2 shows a side perspective view of the exemplary sports training device, in accordance with the present disclosure;

FIG. 3 shows a front view of the exemplary sports training device, in accordance with the present disclosure;

FIG. 4 shows a side view of the exemplary sports training device, in accordance with the present disclosure; and

FIG. 5 shows a cross sectional view of a handle portion of the sports training device, in accordance with the present disclosure.

### DETAILED DESCRIPTION

Before describing in detail exemplary embodiments, it is noted that the embodiments reside primarily in device components related to a sports training device. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The sports training device shown and described herein is a device that is configured to be held by the user and moved in a fluid, such as air and/or water, to generate resistance that contributes to and/or improves muscle recovery, increase in muscle strength, agility, stamina, and/or provides other health and fitness benefits, including training for racket sports such as tennis, padel tennis, squash, racquetball, pickleball, badminton, table tennis, and others. In one embodiment, the device has a shape that is generally similar to a tennis racket, but the device is not configured for use as a tennis racket, or for use in any such dry-land-type racket sports. For example, in one embodiment the device has a weight that is several times greater than a typical tennis racket, which would make it impractical for in-game use, but effective as a training and/or recovery device. Further, in one embodiment the device lacks the typical tensioned strings or smooth face for rebounding a ball, such as in a pickleball racket, and is not particularly suited to returning a ball. In some embodiments, the device facilitates sports training and muscle recovery at least in part due to its increased weight, sturdy design, and hydrodynamic/aerodynamic configuration that enables it to move through fluid with an amount of resistance that is sufficient to engage and develop the user's muscles, while still allowing for efficient movement of the device.

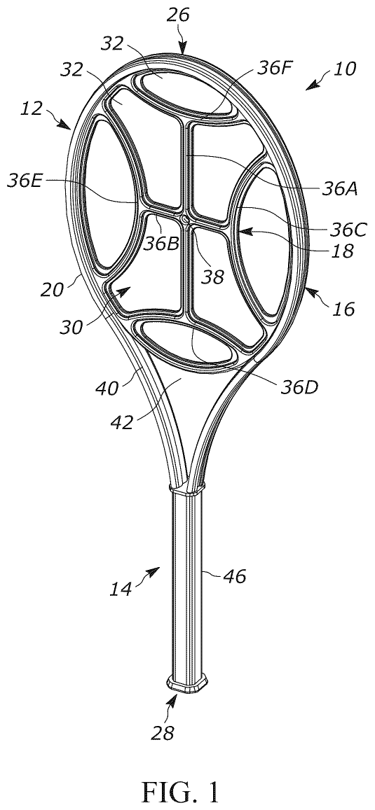

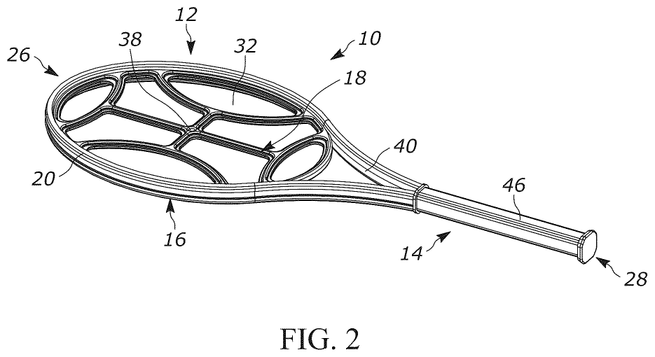

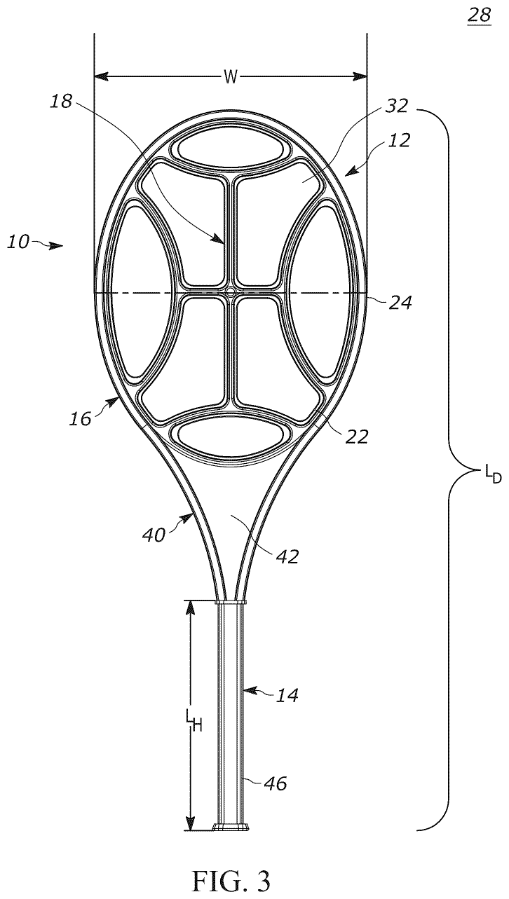

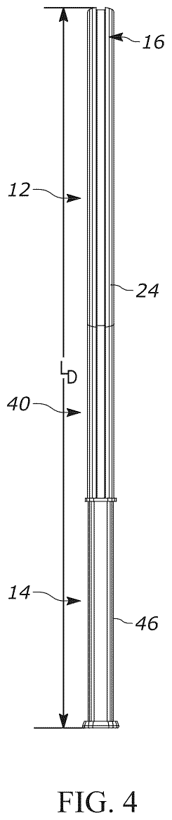

Referring now to FIGS. 1-4, a sports training device 10 is shown. FIG. 1 shows a front perspective view thereof; FIG. 2 shows a side perspective view thereof; FIG. 3 shows a front view thereof; and FIG. 4 shows a side view thereof. In one embodiment, the sports training device 10 (which is also referred to herein as “device” for brevity) generally includes a head portion 12 and a handle portion 14.

Continuing to refer to FIGS. 1-4, in one embodiment the head portion 12 generally includes a frame 16 and a resistance element 18. In one embodiment, the frame 16 is defined by a curved/curvilinear elongate element 20 that lies in a plane to form a tear shape. In one embodiment, the frame 16 includes an inner surface 22 and an outer surface 24. In one embodiment, the frame 16 includes a distal or first end 26 and a proximal or second end 28 opposite the distal end 26. In one embodiment, the proximal end 28 is tapered in the distal-to-proximal direction, with opposite ends of the elongate element 20 joining and/or meeting (being located proximate each other) where the head portion 12 meets the handle portion 14. In one non-limiting example, the distal end 26 is broader than the proximal end 28, with the elongate element 20 making a wide, nearly circular, curve and defining at least one head aperture 30. However, it will be understood that the frame 16 in the head portion 12 may have other suitable shapes and/or configurations, such as oval, rounded polygonal, round, square, rounded square, rectangle, rounded rectangle, or the like, that supports the resistance element 18 and that defines the at least one head aperture 30 through which a fluid, such as water and/or air, may flow. A device 10 having one head aperture 30 is shown in FIGS. 1-4.

Continuing to refer to FIGS. 1-4, in one embodiment the resistance element 18 is positioned within the head aperture 30 and is coplanar, or at least substantially coplanar, with the frame 16. In one embodiment, the resistance element 18 defines at least one resistance element aperture 32. In some embodiments, the at least one resistance element aperture 32 and the at least one head aperture 30 are coincident or at least partially coincident. In one embodiment, the frame 16 and the resistance element 18 are each composed of a rigid, semi-rigid, or semi-flexible material that is non-porous or at least substantially non-porous (does not absorb or retain water), thereby making the device 10 usable in water without disintegrating, becoming waterlogged, or otherwise affecting device integrity. Further, in some embodiments, any seams or gaps between device components are avoided or prevented during manufacture and/or assembly, and/or are sealed during assembly to prevent water or other fluid from entering internal spaces in the device 10 that could affect weight, performance, or other characteristics. In one embodiment, the resistance element 18 and the frame 16 are each composed of the same material or class of material, such as plastic, polymer, or the like. In one embodiment, the resistance element 18 and/or the frame 16 are each composed of and/or are at least partially coated with a material with a low coefficient of friction and/or that reduces drag when the resistance element is moved through a fluid. In one embodiment, the resistance element 18 and the frame 16 are composed of different materials. For example, the frame 16 may be composed of a material having a higher density, and/or the frame may have a greater weight than, the resistance element 18. In another example, the resistance element 18 may be composed of a material having a higher density, and/or the resistance element 18 may have a greater weight than, the frame 16. In another example, the resistance element 18 and the frame 16 may be composed of the same or different materials having the same or substantially the same density and/or weight. In some embodiments, the frame 16, the resistance element 18, and/or other components of the device 10 are composed of carbon fiber, steel (including, but not limited to, stainless steel, marine-grade steel), HDPE (high-density polyethylene), Kevlar, silicone, acrylic, graphite, titanium alloy, and/or other suitable waterproof and/or water-resistant materials. In some embodiments, at least the resistance element 18 is not sized, shaped, or configured, and is not composed of a material that is configured, to provide sufficient bounce and direction (including, but not limited to, predictable direction) to a ball that would make the device 10 suitable for game play (for example, tennis, padel tennis, squash, racquetball, pickleball, badminton, table tennis, and others). In some embodiments, the resistance element 18 is not composed of a solid planar, or at least substantially planar, face, or of a plurality of interwoven strings (such as polyester, nylon, and/or strings of other materials as are commonly used for game-play rackets).

In one embodiment, the device 10 has a weight of between approximately 18 ounces and approximately 36 ounces (±5 ounces), or a weight that is between approximately 2 to 3 times the weight of a commonly used tennis racket. In some embodiments, the weight of the device 10 may be 3 or more times the weight of a commonly used tennis racket, and may be chosen based on the user's size, weight, and/or strength, and/or the user's desired resistance, training purpose, body area of training or rehabilitation, or other variables, purposes, limitations, or intentions. For example, in one embodiment, the device 10 has a weight of between approximately 15 ounces and approximately 75 ounces (±5 ounces). In one embodiment, the device 10 has a weight of between approximately 6 ounces and approximately 14 ounces (±2 ounces). In one embodiment, the device 10 has a weight of at least 30 ounces (±5 ounces). This increased weight may enable the device 10 to help develop a user's agility, strength, and stamina, and to promote skills in racket-based sports. Additionally, this increased weight may allow the device 10 to support at least a portion of the user's body weight when used in certain types of exercises.

Continuing to refer to FIGS. 1-4, in one embodiment the resistance element 18 is coupled to or mounted within the frame 16 (in contact with the inner surface 22 of the frame 16), such as by one or more mechanical connection elements (including, but not limited to, bolts, screws, clamps, snap-in, friction fit, retainer fittings, and the like), chemical adhesion (including, but not limited to, adhesives, polymer adhesives, and the like), and/or other methods (including, but not limited to, soldering, welding, and the like) and/or components used to removably or permanently join two components composed of the same or different materials. Additionally or alternatively, the resistance element 18 and the frame 16 (or at least portions of each) are a single, uniform and/or unitary piece of material (that is, the resistance element 18 and the frame 16 are formed or manufactured together, such as by molding, 3D printing, casting, injection molding, extrusion molding, and the like). In some embodiments, the resistance element 18 is removably attached within the frame 16 such that a user can replace the resistance element 18 with any of a variety of resistance elements having different properties, such as weight, material, density, configuration, resistance to fluid flow, color, etc.

Continuing to refer to FIGS. 1-4, in one embodiment the resistance element 18 is composed of a plurality of connected elongate elements 36 that are linear, curvilinear, angular, and/or curved in shape. A number of configurations of the elongate elements 36 are contemplated. In one non-limiting example, the resistance element 18 defines a central portion 38 from which four elongate elements 36 extend in directions that are 90° or substantially 90° (for example, ±15°) from each other. Put another way, in this non-limiting example the resistance element 18 defines a central portion 38 over which two elongate elements 36 (for example, a first elongate element 36A and a second elongate element 36B), arranged orthogonally or at least substantially orthogonally to each other, are crossed or intersect each other. In one embodiment, each of the first elongate element 36A and the second elongate element 36B are linear or at least substantially linear. In one non-limiting example, at least one end of each elongate element 36A, 36B is connected to, terminates at, and/or is otherwise in contact not with the inner surface 22 of the frame 16, but with a curvilinear or curved elongate element 36C, 36D, 36E, 36F, which in turn is connected to, terminates at, and/or is otherwise in contact with the inner surface 22 of the frame 16. The resistance element 18 does not include a plurality of flexible strings under tension or a plurality of strings in a woven pattern (such as in a typical tennis or badminton racket). However, it will be understood that suitable configurations of the resistance element 18 other than that shown that allow fluid flow therethrough and present a desired amount of resistance when moving through a fluid may be used.

Continuing to refer to FIGS. 1-4, in one embodiment the proximal end 28 of the frame 16 and at least a portion of the resistance element 18 together define a throat region 40 that, in one non-limiting example, includes a throat aperture 42. In one embodiment, the throat aperture 42 is bound by the resistance element 18 and the frame 16. In some embodiments, the throat aperture 42 is also bound by the handle portion 14. However, in other embodiments the device 10 does not include a throat region 40 or throat aperture 42, and instead the resistance element 18 extends across and/or within the entire head aperture 30.

Continuing to refer to FIGS. 1-4, in one embodiment the handle portion 14 is elongated, and includes a handle 46 that is sized and configured to be held in a human hand when the device 10 is in use. In some embodiments, the handle 46 and the handle portion 14 are coextensive. In other embodiments, the handle 46 is a portion of, or less than the entirety of, the handle portion 14. In one embodiment, at least a portion of the handle 46 is composed of and/or is coated, wrapped, sleeved, and/or surfaced with a material that has a higher coefficient of friction than the frame 16 and/or resistance element 18 to enhance grip. For example, the handle 46 may be composed of, coated, wrapped, sleeved, and/or surfaced with a rubber (or rubberized material) such as natural rubber, polyurethane, silicone, or neoprene.

Continuing to refer to FIGS. 1-4, in some embodiments, the head portion 12 of the device 10 (measured at the widest point of the head portion) has a width W of approximately 10 inches (±1 inch). Thus, the entire device 10 has a maximum width of approximately 10 inches (±1 inch). In some embodiments, the handle portion 14 (and/or the handle 46) has a length L_{H} of approximately 8 inches (±1 inch). In some embodiments, the entire device 10 has a length L_{D} of approximately 27 inches (±1 inch). However, other suitable sizes and configurations may be used. For example, a variety of sizes and configurations may be used to suit the fitness level, age, size, training goal, and/or other characteristics and objectives of the user.

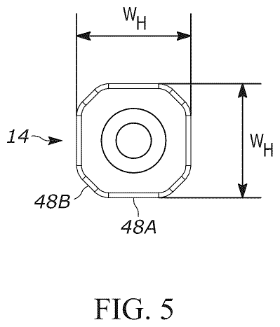

Referring now to FIG. 5, a cross sectional view of the handle portion 14 is shown. As noted above, in some embodiments the handle 46 has a size and configuration, including the shape and contours of outer surfaces of the handle portion 14, that are well suited to being grasped in a human hand. In one non-limiting example, as shown in FIG. 5, the handle portion 14 has a polygonal cross-sectional shape, including, but not limited to, an octagonal shape. In one non-limiting example, as shown in FIG. 5, the octagonal cross-sectional shape includes four major faces 48A and four minor faces 48B. In this embodiment, each of the four major faces 48A have the same or approximately the same width and each of the four minor faces 48B have the same or approximately the same width, which is different than the width of each of the four major faces 48A. In one non-limiting example, each of the four major faces 48A has a width W_{H} of approximately 1 inch (±0.5 inch). However, it will be understood that other suitable sizes, shapes, and configurations may be used. For example, the handle 46 may have a round or oval cross-sectional shape, or may have another polygonal shape.

In one embodiment, a method of using the device includes a user swinging the device under water. For example, a user may be in a pool and may swing or move the device at least partially beneath the surface of the water, where the flow of the water through the resistance element apertures 32 will provide an amount of resistance that is sufficient or suitable to achieve the purposes discussed herein, namely, sports training, strength training, physical rehabilitation from injury or weakness, movement training, and/or other user objectives.

### Embodiments

In one embodiment, a device comprises: a head portion; a handle portion meeting the head portion; and a resistance element within and extending across the head portion.

In one aspect of the embodiment, the head portion is at least substantially planar.

In one aspect of the embodiment, the resistance element is at least substantially planar and is coplanar with the head portion.

In one aspect of the embodiment, the resistance element defines a plurality of apertures.

In one aspect of the embodiment, the plurality of apertures are configured to allow a flow of fluid to pass therethrough when the device is in use.

In one aspect of the embodiment, the device weighs between approximately 18 ounces and approximately 36 ounces.

In one aspect of the embodiment, the device weighs at least 30 ounces.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A device comprising:
a head portion at a first end of the device;
a handle portion at a second end of the device; and
a resistance element within and extending across the head portion.

2. The device of claim 1, wherein the head portion is at least substantially planar.

3. The device of claim 2, wherein the resistance element is at least substantially planar and is coplanar with the head portion.

4. The device of claim 1, wherein the resistance element defines a plurality of apertures.

5. The device of claim 4, wherein the plurality of apertures are configured to allow a flow of fluid to pass therethrough when the device is in use.

6. The device of claim 1, wherein the device weighs between approximately 6 ounces and approximately 36 ounces.

7. The device of claim 1, wherein the device weighs at least 30 ounces.

8. The device of claim 1, wherein the resistance element is at least partially defined by a plurality of elongate elements.

9. The device of claim 8, wherein the resistance element includes a central portion, the plurality of elongate elements including a linear first elongate element and a linear second elongate element, the linear first elongate element and the linear second elongate element intersecting at the central portion.

10. The device of claim 9, wherein the plurality of elongate elements further includes a plurality of curved elongate elements.

11. The device of claim 10, wherein each of the linear first elongate element and the linear second elongate element terminates at a corresponding one of the plurality of curved elongate elements.

12. The device of claim 1, further comprising a throat region, the throat region being positioned between the head portion and the handle portion.

13. The device of claim 12, wherein the throat region defines a throat aperture.

14. The device of claim 1, wherein the head portion and the resistance element are formed as a single, unitary piece.

15. The device of claim 1, wherein the head portion defines a head aperture, the resistance element being attached within the head aperture.

16. The device of claim 1, wherein the resistance element does not include a plurality of interwoven strings.

17. A device comprising:
a head portion at a first end of the device, the head portion defining a head aperture;
a handle portion at a second end of the device; and
a resistance element within and extending across the head aperture,
the device having a weight of between approximately 6 ounces and approximately 36 ounces.

18. The device of claim 17, wherein the head portion is at least substantially planar and the resistance element is at least substantially planar, the resistance element being coplanar with the head portion.

19. The device of claim 17, wherein the resistance element defines a plurality of apertures.

20. A method of physical rehabilitation and sports training, the method comprising:
moving a sports training device at least partially beneath a surface of water, the sports training device including:
a head portion at a first end of the device, the head portion defining a head aperture;
a handle portion at a second end of the device; and
a resistance element within and extending across the head aperture,
the device having a weight of between approximately 6 ounces and approximately 36 ounces.
